(19) United States
(12) Patent Application Publication
(10) Pub. No.: US 2016/0052367 A1
(43) Pub. Date: Feb. 25, 2016

(54) ENERGY ABSORBING AIR HANDLING DEVICE FOR A VEHICLE

(71) Applicant: GM GLOBAL TECHNOLOGY OPERATIONS LLC, Detroit, MI (US)

(72) Inventors: Shawn G. Quinn, Waterford, MI (US); Khristopher S. Lee, Oakland Township, MI (US); Doru N. Serban, Richmond Hill (CA)

(21) Appl. No.: 14/467,335

(22) Filed: Aug. 25, 2014

(51) Int. Cl. B60H 1/26

(52) U.S. Cl. CPC B60H 1/262; B60H 1/267; B60R 2019/005

(57) ABSTRACT

A vehicle includes a body, which forms a passenger compartment, and including a roof. The roof defines an upper vertical boundary of the passenger compartment. An air handling duct is disposed adjacent the roof, within the passenger compartment of the body. The air handling duct defines an internal cavity, which is operable to deliver a flow of air to the passenger compartment. The air handling duct includes an energy management system that is disposed within the internal cavity of the air handling duct. The energy management system includes at least one pillar, which is operable to deform against the roof to absorb energy transferred to the air handling duct from within the passenger compartment.

### TECHNICAL FIELD

The disclosure generally relates to an air handling duct for delivering a flow of air to a passenger compartment of a vehicle, adjacent a roof of the vehicle.

### BACKGROUND

Many vehicles, such as sedans, or particularly Sport Utility Vehicles (SUVs) and vans that include multiple rows of rear passenger seating, often include an air handling duct incorporated into the headliner, adjacent a roof of the vehicle. The air handling duct delivers a flow of air into a passenger compartment, through vents disposed adjacent the roof of the vehicle. Vehicles also may include energy management systems that are incorporated into the headliner, adjacent the roof of the vehicle. The energy management systems are configured for absorbing and/or dissipating energy from an applied load. Often, the packaging and/or placement of the air handling duct and the energy management system adjacent the roof, conflict with each other.

### SUMMARY

A vehicle is provided. The vehicle includes a body forming a passenger compartment, and including a roof. The roof defines an upper vertical boundary of the passenger compartment. An air handling duct is disposed adjacent the roof, within the passenger compartment of the body. The air handling duct defines an internal cavity, which is operable to deliver a flow of air to the passenger compartment. The air handling duct includes an energy management system that is disposed within the internal cavity of the air handling duct. The energy management system is operable to react against the roof of the body to absorb energy transferred to the air handling duct from within the passenger compartment.

An air handling duct for delivering a flow of air, adjacent a roof, within a passenger compartment of a vehicle, is also provided. The air handling duct includes a bottom wall that defines a lower boundary of an internal cavity. At least one vent is disposed in the bottom wall, for directing a flow of air from the internal cavity into the passenger compartment of the vehicle. At least one pillar extends vertically upward from the bottom wall, within the internal cavity. The pillar is deformable in response to an applied load to absorb energy from the applied load.

Accordingly, the energy management system is incorporated into the internal cavity of the air handling duct, thereby reducing the number of components of the vehicle, and simplifying the packaging within the passenger compartment adjacent the roof of the vehicle. In response to an applied load, the energy management system reacts against the roof and is deformable to absorb energy of the applied load.

The above features and advantages and other features and advantages of the present teachings are readily apparent from the following detailed description of the best modes for carrying out the teachings when taken in connection with the accompanying drawings.

### BRIEF DESCRIPTION OF THE DRAWINGS

FIG. 1 is a schematic cross sectional side view of a vehicle showing an air handling duct.

FIG. 2 is an enlarged fragmentary cross sectional view of the vehicle showing the air handling duct.

FIG. 3 is an enlarged fragmentary plan view of the air handling duct.

FIG. 4 is an enlarged fragmentary cross sectional view of the vehicle showing the air handling duct in response to an applied load.

### DETAILED DESCRIPTION

Those having ordinary skill in the art will recognize that terms such as “above,” “below,” “upward,” “downward,” “top,” “bottom,” etc., are used descriptively for the figures, and do not represent limitations on the scope of the disclosure, as defined by the appended claims. Furthermore, the teachings may be described herein in terms of functional and/or logical block components and/or various processing steps. It should be realized that such block components may be comprised of any number of hardware, software, and/or firmware components configured to perform the specified functions.

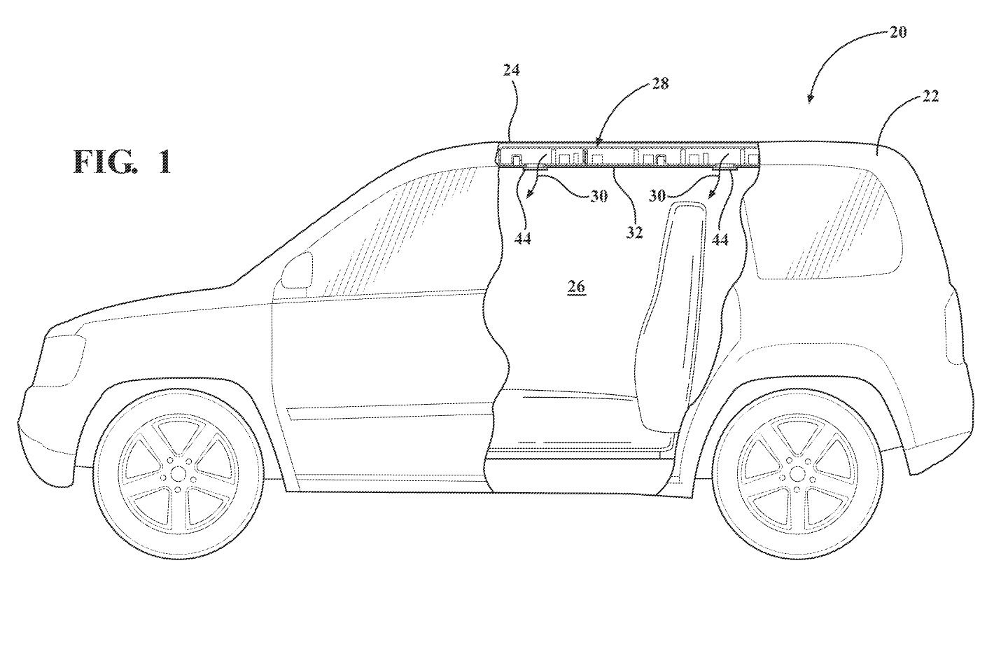

Referring to the Figures, wherein like numerals indicate like parts throughout the several views, a vehicle is generally shown at 20. Referring to FIG. 1, the vehicle 20 includes a body 22 having a roof 24. The body 22 forms and/or defines a passenger compartment 26, with the roof 24 defining an upper vertical boundary of the passenger compartment 26. The vehicle 20 may be configured in any suitable manner, such as but not limited to a Sport Utility Vehicle (SUV) or a van.

The vehicle 20 includes an air handling duct 28 that is disposed adjacent the roof 24, within the passenger compartment 26 of the vehicle 20. The air handling duct 28 is operable to deliver a flow of air 30 into the passenger compartment 26, adjacent the roof 24 of the vehicle 20. The air handling duct 28 may be covered from view from within the passenger compartment 26 by a headliner 32 or other similar trim piece.

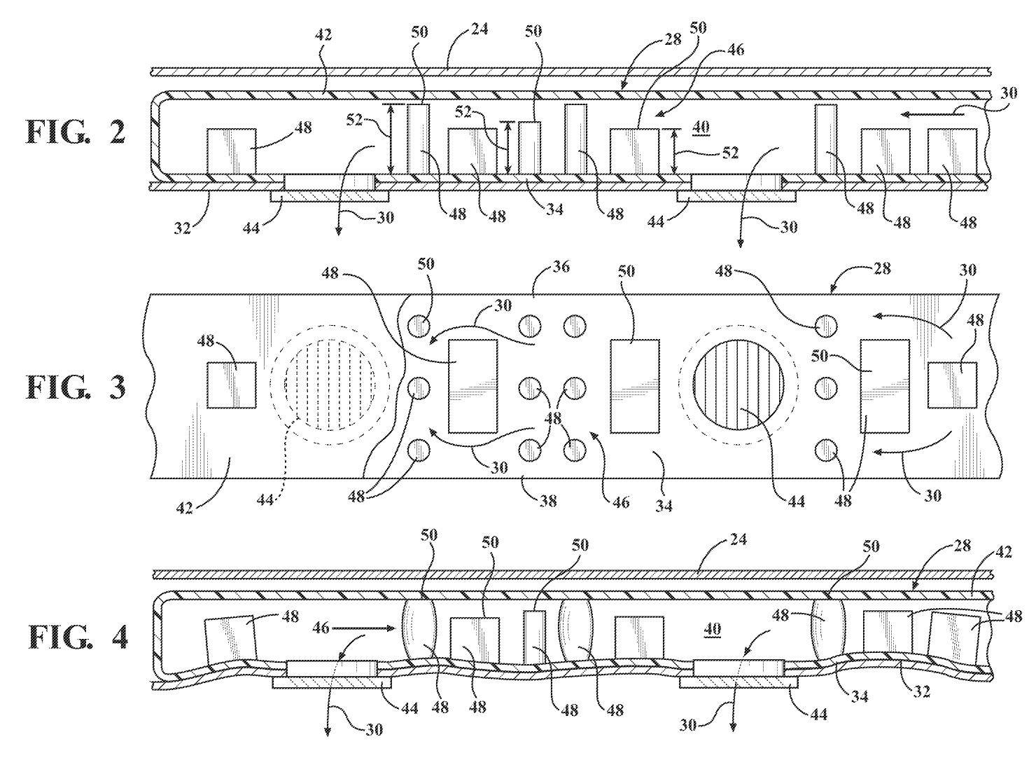

Referring to FIGS. 2 and 3, the air handling duct 28 includes a bottom wall 34. Depending on how the air handling duct 28 is configured for the exact design and/or packaging constraints of the vehicle 20, the air handling duct 28 may further include, as shown, a first side wall 36, and a second side wall 38. Both of the first side wall 36 and the second side wall 38 extend vertically upward from the bottom wall 34, and are disposed on opposite lateral sides of the bottom wall 34, across the bottom wall 34 from each other.

The bottom wall 34, the first side wall 36, and the second side wall 38 cooperate to define an internal cavity 40 therebetween. The internal cavity 40 is operable to direct and deliver the flow of air 30 from a source to the passenger compartment 26. The source may include a heating ventilation air conditioning system, such as known in the art. The bottom wall 34 defines a lower boundary to the internal cavity 40, the first side wall 36 defines a first lateral boundary to the internal cavity 40, and the second side wall 38 defines a second lateral boundary to the internal cavity 40.

The air handling duct 28 may further include, as shown, an upper wall 42 that is attached to the first side wall 36 and the second side wall 38. The upper wall 42 is disposed adjacent the roof 24. The upper wall 42 is spaced vertically above the bottom wall 34, and defines an upper boundary to the internal cavity 40. If the air handling duct 28 is configured to not include the upper wall 42, then the roof 24 may cooperate with the first side wall 36 and the second side wall 38 to form an upper boundary to the internal cavity 40.

The air handling duct 28 includes at least one vent 44, and preferably a plurality of vents 44. The vents 44 are operable to direct the flow of air 30 from the internal cavity 40 of the air handling duct 28, into the passenger compartment 26 of the body 22. The vents 44 may be configured in any suitable manner, and are preferably disposed in the bottom wall 34 of the air handling duct 28. It should be appreciated that the vents 44 may pass through the headliner 32 as well, so that the air 30 from the air handling duct 28 may be directed into the passenger compartment 26.

The air handling duct 28 includes an energy management system 46, which is disposed within the internal cavity 40 of the air handling duct 28. The energy management system 46 is operable to react against the roof 24 of the body 22 to absorb energy transferred to the air handling duct 28 from within the passenger compartment 26. Accordingly, in response to an object contacting the air handling duct 28 and thereby imparting an applied load to the air handling duct 28, the energy management system 46 absorbs some or all of the energy from the applied load.

The energy management system 46 may be incorporated into the internal cavity 40 of the air handling duct 28 in any suitable manner, and may be configured in any suitable manner capable of absorbing energy. As shown in the Figures, the energy management system 46 is attached to the bottom wall 34 of the air handling duct 28, and extends vertically upward from the bottom wall 34, toward the roof 24 of the vehicle 20.

As shown in the Figures as an exemplary embodiment, the energy management system 46 includes at least one pillar 48, which extends from the bottom wall 34. Preferably and as shown the energy management system 46 includes a plurality of pillars 48 laterally spaced from each other throughout the internal cavity 40 of the air handling duct 28. The pillars 48 may be arranged and/or positioned relative to the passenger compartment 26 in a pattern configured to optimize energy absorption within specific areas of the passenger compartment 26, such as directly above seats.

The pillars 48 may include any desirable shape and/or size, such as but not limited to a rectangular block or a cylindrical tube. The pillars 48 may all be sized and shaped in a uniform and consistent manner. Alternatively, the pillars 48 may include different sizes and/or shapes. The size, shape, number, and material of the pillars 48 may be designed and/or selected to meet a pre-determined force resistance or energy absorption profile. As such, the amount of energy absorbed by each of the pillars 48, and the amount of energy absorbed by the combination of pillars 48, is dependent upon the size, shape, number and material of the pillars 48, and may be adjusted to satisfy specific design requirements.

The pillars 48 preferably include a deformable, energy absorbing material, capable of reducing the amplitude of vibration or oscillation in the pillars 48. For example, the pillars 48 may include and be manufactured from, but are not limited to, a viscoelastic material, a thermoplastic elastomer material, or some other energy absorbing material. Furthermore, the energy absorbing material may be formed to include internal voids or pockets, which are capable of compression and/or deformation.

The pillars 48 may extend upward from the bottom wall 34 to a distal end 50. The distal end 50 may be spaced from the upper wall 42 and/or the roof 24 of the vehicle 20, prior to application of the applied load. Accordingly, the distal ends 50 of the pillars 48 may be vertically spaced below the roof 24 prior to application of the applied load to the air handling duct 28. If the air handling duct 28 is configured to include the upper wall 42, then at least one of the pillars 48 may extend completely between the lower wall and the upper wall 42 prior to application of the applied load, and may be disposed in contact or engagement with the roof 24 prior to application of the applied load.

Referring to FIG. 4, the pillars 48 are deformable in response to the applied load to absorb energy from the applied load. If the distal ends 50 of the pillars 48 are spaced from the roof 24 when the applied load is applied to the air handling duct 28, the bottom wall 34 and the pillars 48 are urged upward into engagement or contact with the roof 24 in response to the applied load. Upon contacting and/or engaging the roof 24, the pillars 48 react against the roof 24 and deform, e.g., compressing or bending. The pillars 48 absorb energy as the pillars 48 deform, thereby reducing the severity of the forces applied against the roof 24.

Referring to FIG. 2, each of the pillars 48 includes a height 52, which is measured between the distal end 50 thereof and the bottom wall 34. The height 52 of the pillars 48 may all be uniform. Alternatively, the height 52 of at least one of the pillars 48 may be different from the height 52 of at least one other of the pillars 48, thereby providing pillars 48 of different lengths. As such, the pillars 48 will deform at different times during in response to an applied force. In so doing the energy absorption profile of the energy management system 46 may be tuned to meet desired design parameters.

In addition to positioning the pillars 48 within the internal cavity 40 of the air handling duct 28 to control the energy absorption profile of the energy management system 46, the pillars 48 may be positioned and sized within the internal cavity 40 to control and/or tune the flow of air 30 through the internal cavity 40, and through the vents 44 into the passenger compartment 26. Accordingly, the number, size, shape and location of the pillars 48 within the internal cavity 40 may be designed and/or selected to control and/or tune the flow characteristics of the flow of air 30 through the internal cavity 40, so that a consistent quantity and/or flow rate of air 30 is provided to each of the different vents 44 of the air handling duct 28.

The air handling duct 28 may be constructed in any suitable manner. For example, the air handling duct 28 may be constructed by a two shot molding process. The two shot molding process produces a molded part, e.g., the air handling duct 28, from two different materials in two different molding steps. For example, the bottom wall 34, and maybe the first side wall 36 and the second side wall 38 if so configured, may be molded in a first step from a first plastic material. The pillars 48 of the energy management system 46 may then be molded onto/into the bottom wall 34, from the energy absorbing material, to form the completed air handling duct 28. The pillars 48 are then integrally formed with or bonded to the bottom wall 34, but are formed from a different material than that used to form the bottom wall 34.

The detailed description and the drawings or figures are supportive and descriptive of the disclosure, but the scope of the disclosure is defined solely by the claims. While some of the best modes and other embodiments for carrying out the claimed teachings have been described in detail, various alternative designs and embodiments exist for practicing the disclosure defined in the appended claims.

1. A vehicle comprising:
a body forming a passenger compartment, and including a roof defining an upper vertical boundary of the passenger compartment; and
an air handling duct disposed adjacent the roof within the passenger compartment of the body, and defining an internal cavity operable to deliver a flow of air to the passenger compartment;
wherein the air handling duct includes an energy management system disposed within the internal cavity of the air handling duct, and operable to react against the roof of the body to absorb energy transferred to the air handling duct from within the passenger compartment.

2. A vehicle as set forth in claim 1 wherein the air handling duct includes a bottom wall, with the energy management system attached to and extending vertically upward from the bottom wall.

3. A vehicle as set forth in claim 2 wherein the energy management system includes at least one pillar extending from the bottom wall to a distal end, wherein the at least one pillar is deformable in response to an applied load to absorb energy from the applied load.

4. A vehicle as set forth in claim 3 wherein the at least one pillar reacts against the roof during deformation.

5. A vehicle as set forth in claim 3 wherein the at least one pillar includes a deformable energy absorbing material.

6. A vehicle as set forth in claim 5 wherein the at least one pillar includes a viscoelastic material or a thermoplastic elastomer material.

7. A vehicle as set forth in claim 3 wherein the at least one pillar includes a plurality of pillars laterally spaced from each other throughout the internal cavity.

8. A vehicle as set forth in claim 7 wherein each of the plurality of pillars includes a height measured from the bottom wall, and wherein the height of at least one of the plurality of pillars is different from at least one other of the plurality of pillars.

9. A vehicle as set forth in claim 3 wherein the distal end of the at least one pillar is vertically spaced below the roof prior to application of the applied load to the air handling duct, and wherein the at least one pillar moves vertically upward into engagement with the roof in response to the applied load, whereupon the at least one pillar reacts against the roof to deform.

10. A vehicle as set forth in claim 3 wherein the at least one pillar is sized and positioned within the internal cavity to control and tune the flow of air through the internal cavity.

11. A vehicle as set forth in claim 3 wherein the air handling duct includes a first side wall and a second side wall, both extending vertically upward from the bottom wall, and wherein the bottom defines a lower boundary to the internal cavity, the first side wall defines a first lateral boundary to the internal cavity, and the second side wall defines a second lateral boundary to the internal cavity.

12. A vehicle as set forth in claim 11 wherein the air handling duct includes an upper wall attached to the first side wall and the second side wall adjacent the roof, and spaced vertically above the bottom wall, and wherein the upper wall defines an upper boundary to the internal cavity.

13. A vehicle as set forth in claim 12 wherein the at least one pillar extends between the lower wall and the upper wall prior to application of the applied load.

14. A vehicle as set forth in claim 11 wherein the roof cooperates with the air handling duct to form an upper boundary to the internal cavity.

15. A vehicle as set forth in claim 1 wherein the air handling duct includes at least one vent operable to direct air from the internal cavity of the air handling duct into the passenger compartment of the body.

16. An air handling duct for delivering a flow of air, adjacent a roof within a passenger compartment of a vehicle, the air handling duct comprising:
a bottom wall defining a lower boundary of an internal cavity;
at least one vent disposed in the bottom wall for directing a flow of air from the internal cavity into the passenger compartment of the vehicle; and
at least one pillar extending vertically upward from the bottom wall, within the internal cavity, wherein the at least one pillar is deformable in response to an applied load to absorb energy from the applied load.

17. An air handling duct as set forth in claim 16 wherein the at least one pillar includes a viscoelastic material or a thermoplastic elastomer material.

18. An air handling duct as set forth in claim 17 wherein the at least one pillar includes a plurality of pillars laterally spaced from each other throughout the internal cavity.

19. An air handling duct as set forth in claim 18 wherein the plurality of pillars are sized and positioned within the internal cavity to control the flow of air through the internal cavity, and to the at least one vent.

20. An air handling duct as set forth in claim 19 further comprising a first side wall and a second side wall, both extending vertically upward from the bottom wall and disposed on opposing lateral sides of the bottom wall across from each other, and wherein the first side wall defines a first lateral boundary to the internal cavity, and the second side wall defines a second lateral boundary to the internal cavity.
